(19) United States
(12) Patent Application Publication
(10) Pub. No.: US 2015/0288628 A1
(43) Pub. Date: Oct. 8, 2015

(54) CHAT SYSTEM

(71) Applicants: NEC PLATFORMS, LTD., Kawasaki-shi (JP); NEC CORPORATION, Tokyo (JP)

(72) Inventors: Nobuo NISHIDE, Tokyo (JP); Mitsuharu KASAHARA, Kanagawa (JP)

(73) Assignees: NEC PLATFORMS, LTD., Kawasaki-shi (JP); NEC CORPORATION, Tokyo (JP)

(21) Appl. No.: 14/600,110

(22) Filed: Jan. 20, 2015

(30) Foreign Application Priority Data
Apr. 8, 2014 (JP) 2014-079150

(51) Int. Cl. H04L 12/58; H04W 4/12; H04L 29/08

(52) U.S. Cl. CPC H04L 51/046; H04L 67/104; H04L 67/24; H04W 4/12

(57) ABSTRACT

A chat system includes a key telephone unit and a plurality of user terminals connected to the key telephone unit. When the key telephone unit receives an IP address of the user terminal, it refers to a corresponding list in a list table, includes the received IP address in presence information, and transmits the presence information to an addressee in the list. Thus, the key telephone unit establishes peer-to-peer chat communication between the user terminal that has transmitted the IP address and the addressee.

This application is based upon and claims the benefit of priority from Japanese patent application No. 2014-79150, filed on Apr. 8, 2014, the disclosure of which is incorporated herein in its entirety by reference.

### TECHNICAL FIELD

The present invention relates to a chat system.

### BACKGROUND ART

Along with popularization of smart phones and the like, chat communication has frequently been used with smart phones and the like. A server for managing chat communication is required in order to construct a chat system for exchanging chats in real time between clients such as smart phones. The server always recognizes IP addresses of chat clients, so that each of the clients does not have to know an IP address of a companion client.

However, small-sized offices are reluctant to use openly provided services for their business. Furthermore, a small-sized office faces high hurdles in cost, human resources for managing the system, and the like to prepare a server and construct its own chat system.

Patent Literature 1 (JP-A 2004-192331) discloses a communication terminal device, a communication server and communication method for real-time interactive communication such as chats. Specifically, Patent Literature 1 discloses a system capable of displaying images as well as texts in order to enhance realistic sensation of peer-to-peer (P2P) chat communication between personal computers. Thus, Patent Literature 1 discloses a communication system for providing a peer-to-peer chat service between personal computers via the Internet and also discloses a communication system for providing a peer-to-peer chat service between personal computers via the Internet and a server.

### SUMMARY

However, the system disclosed in Patent Literature 1 cannot sufficiently satisfy demands on a chat system for small-sized offices or the like. In other words, small-sized offices are reluctant to use openly provided services such as the Internet but cannot accept the cost required to prepare their own server for a chat system.

It is, therefore, an exemplary object of the present invention to provide a chat system capable of solving at least one of the aforementioned problems.

Another exemplary object of the present invention is to provide a chat system suitable for small-sized offices and the like.

According to an exemplary aspect of the present invention, a chat system has a key telephone unit and a plurality of user terminals connected to the key telephone unit. When the key telephone unit receives an IP address of any one of the user terminals, it refers to a list in a list table corresponding to the IP address and transmits the IP address to an addressee in the list, thereby achieving chat communication between the user terminal and the addressee which is another one of the user terminals. Peer-to-peer chat communication is established between the user terminals according to the IP address of the user terminal and an IP address of the addressee. The IP addresses of the user terminal and the addressee are included and transmitted in presence information.

### BRIEF DESCRIPTION OF THE DRAWINGS

FIG. 1 is a block diagram explanatory of the concept of a general chat system;

FIG. 2 is a block diagram showing a chat system according to a first exemplary embodiment of the present invention;

FIG. 3 is a block diagram showing a chat system according to a second exemplary embodiment of the present invention;

FIG. 4 is a block diagram showing a specific arrangement of the chat system illustrated in FIG. 2;

FIG. 5 is a diagram showing an instance of a buddy list table stored in a key telephone unit illustrated in FIG. 4; and

FIG. 6 is a diagram showing an instance of an IP address table stored in a user terminal.

### EXEMPLARY EMBODIMENT

First, a general chat system will be described in order to clarify differences between a chat system according to the present invention and the general chat system.

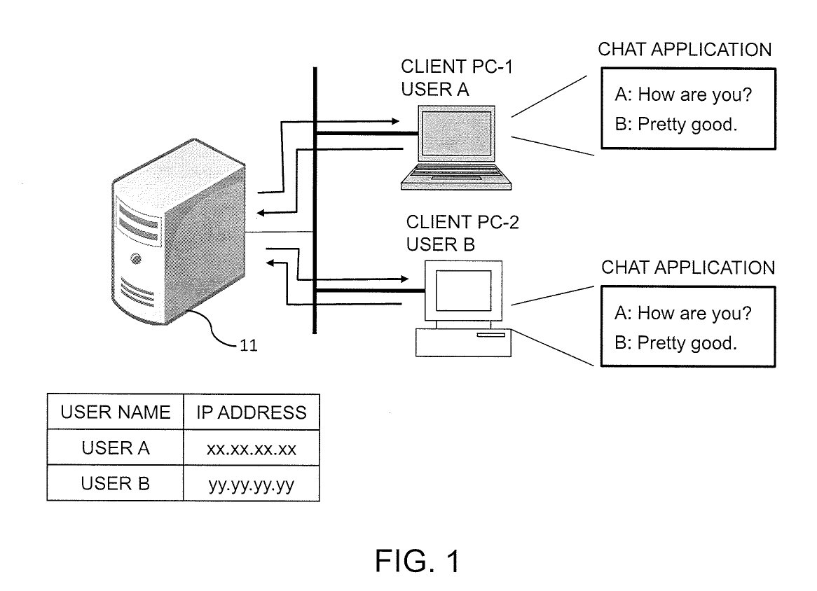

FIG. 1 shows a general chat system. The illustrated chat system includes a chat server 11 and a plurality of client terminals, e.g., personal computers (hereinafter referred to as client PCs) (PC-1 and PC-2 in this illustrated example). The chat server 11 manages IP addresses of the client PCs connected to the chat server 11. Therefore, the client PC-1 does not need to recognize the IP address of the client PC-2 as a chat addressee. However, the illustrated chat system requires the chat server 11 to be provided. Thus, this chat system is not suitable for small-sized offices.

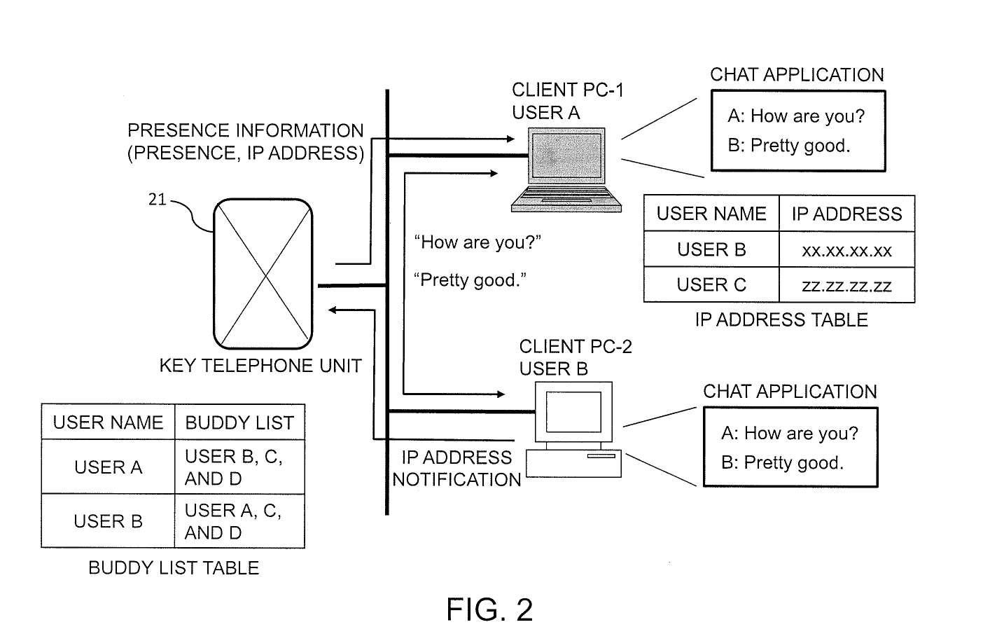

FIG. 2 shows a chat system according to a first exemplary embodiment of the present invention. The illustrated chat system includes a key telephone unit 21 and a plurality of client PCs connected to the key telephone unit 21. The key telephone unit 21 distributes IP addresses as part of data of presence information.

The key telephone unit 21 is also called a main equipment and controls a plurality of key telephone sets, which are not shown, in addition to the client PCs. The key telephone unit 21 includes a presence server managing presence information of the client PCs.

Here, the presence information is defined as information indicating the current state of each client PC (or its user) (for example, online, offline, tea beak, and the like). The presence information can be generated based on various kinds of information such as a state change notification transmitted automatically and/or manually from each client PC, pre-registered schedule information, monitoring results by the key telephone unit 21, and a response to an inquiry from the key telephone unit 21.

When a state (or presence information) of a client PC is changed, the key telephone unit 21 notifies another associated client PC(s) (buddy (-dies)) of the presence information indicating such a state change. In this event, the key telephone unit 21 includes an (latest) IP address of the client PC whose state is changed in the presence information as a part.

Thus, an IP address is included in the presence information distributed by the key telephone unit 21. Accordingly, the client PC-1 (a user terminal A) can obtain an IP address of the client PC-2 (a user terminal B). In this manner, peer-to-peer communication can be established between the client PC-1 and the client PC-2. Note that, in the description, the term of “user terminal A” means a client PC related to (or used by) a user A while the term of “user terminal B” means a client PC related to (or used by) a user B.

The illustrated key telephone unit 21 includes a buddy list table, in which buddy lists for the user terminals A and B (as indicated by “User A” and “User B”) are stored. In the illustrated example, a buddy list for the user terminal A includes the user terminals B, C, and D (as indicated by “User B, C, and D”), and a buddy list for the user terminal B includes the user terminals A, C, and D (as indicated by “User A, C, and D”).

Now an operation of the chat system shown in FIG. 2 will be described. It is assumed that the user terminal B starts a user chat program of the client PC-2. In this case, when the user terminal B logs in, the key telephone unit 21 is notified of the IP address of the client PC-2. Therefore, the key telephone unit 21 detects that the state of the client PC-2 has been changed.

When the IP address of the client PC-2 (i.e., user terminal B) is received, the key telephone unit 21 obtains the user terminal A, the user terminal C, and the user terminal D, for which the user terminal B has been registered as a buddy, from the buddy list table and notifies the user terminal A, the user terminal C, and the user terminal D of the presence information of the user terminal B. In other words, the user terminals A, C, and D registered in the buddy list for the user terminal B in the buddy list table are notified of the presence information of the user terminal B.

The presence information transmitted from the illustrated key telephone unit 21 includes the IP address of the user terminal B as well as the presence (online, offline, tea beak, and the like) of the user terminal B. In addition, an IP address of each addressee is added to the presence information.

As is apparent from the above, the illustrated key telephone unit 21 has a function of receiving an IP address from a user terminal, referring to a buddy list corresponding to the IP address within the buddy list table, and transmitting the received IP address to one or more addressees in the buddy list. In this case, the IP address is included in the presence information, which is transmitted from the key telephone unit 21.

In other words, the illustrated key telephone unit 21 operates in accordance with a key telephone unit program configured to select one or more recipient user terminals from the buddy list table in response to an IP address received from a user terminal and output presence information including the received IP address to the recipient user terminals.

Meanwhile, if the user terminal A has already been online, it receives the presence information including the IP address of the user terminal B, which is transmitted from the key telephone unit 21. The user terminal A (client PC-1) that has received the presence information can transmit chat data to the IP address of the user terminal B (client PC-2), which has been obtained from the key telephone unit 21, using a peer-to-peer method.

Each of the user terminals A and B has an IP address table. The IP address table includes IP addresses stored in association with the names of user terminals. The names of the user terminals that are stored in the IP address table correspond to the names of the user terminals included in the buddy lists for the respective user terminals in the buddy list table of the key telephone unit 21. When the user terminal A receives the presence information of the user terminal B, it stores the IP address included in the presence information into the IP address table so that the IP address corresponds to the name of the user terminal In the illustrated example, IP addresses corresponding to the user terminals B and C are stored in the IP address table of the user terminal A.

It is assumed that the user terminal A (client PC-1) transmits chat data (“How are you?” in the illustrated example) to the IP address of the user terminal B (client PC-2). When the user terminal B (client PC-2) receives the chat data, it can read and obtain an IP address of the user terminal A (client PC-1), which is a sender of the chat data, from the received chat data. Therefore, the user terminal B (client PC-2) can also transmit chat data to the user terminal A (client PC-1) using the peer-to-peer method. In the illustrated example, chat data “Pretty good.” is transmitted from the user terminal B to the user terminal A.

Thus, in this embodiment of a chat system according to the present invention, a chat program for each of the user terminals A and B has a function of transmitting its own IP address to the key telephone unit 21 by including the IP address in information indicating a state change of the user terminal (i.e., presence information) or by adding the IP address to the presence information. Specifically, a user terminal chat program, which is used in each of the user terminals A and B, includes a step of receiving presence information including an IP address of another user terminal on chatting. Furthermore, the user terminal chat program includes a step of reading out an IP address of another user terminal that has communicated with the user terminal from received chat data.

Thus, in this embodiment, peer-to-peer chat communication can be established between client terminals by adding an IP address to presence information and distributing the presence information. Since no chat server is required in this system, the cost for installing and maintaining the system can be reduced for a small-sized office.

In the example shown in FIG. 2, the description is directed to a case where the user terminal A is in an online state. However, the present invention is applicable to a case where the user terminal B is in an offline state.

If the user terminal A is offline or the like (e.g., the terminal has been turned off or a chat application is not started), the user terminals B will be notified of the IP address of the user terminal A that is added to presence information in the same manner as described above when a user chat program is started on the user terminal A. In this event, if the user terminal B transmits chat data to the user terminal A, peer-to-peer chat communication can be established between the user terminals A and B.

In this case, there is a case where the user terminal B desires to transmit the chat data as quickly as possible when the user terminal A becomes online. Because the chat system according to the present invention is operable in conjunction with presence change of the user terminals, it can achieve such quick transmission of the chat data. Specifically, each user terminal may include a storage device capable of holding chat data to transmit the chat data immediately when the addressee becomes online. With this configuration, the chat data held in the storage device is transmitted immediately to the addressee when the addressee becomes online and thereby enabling chat communication promptly. Thus, the chat system according to the present invention can transmit promptly chat data to the addressee in response to the presence change of the addressee.

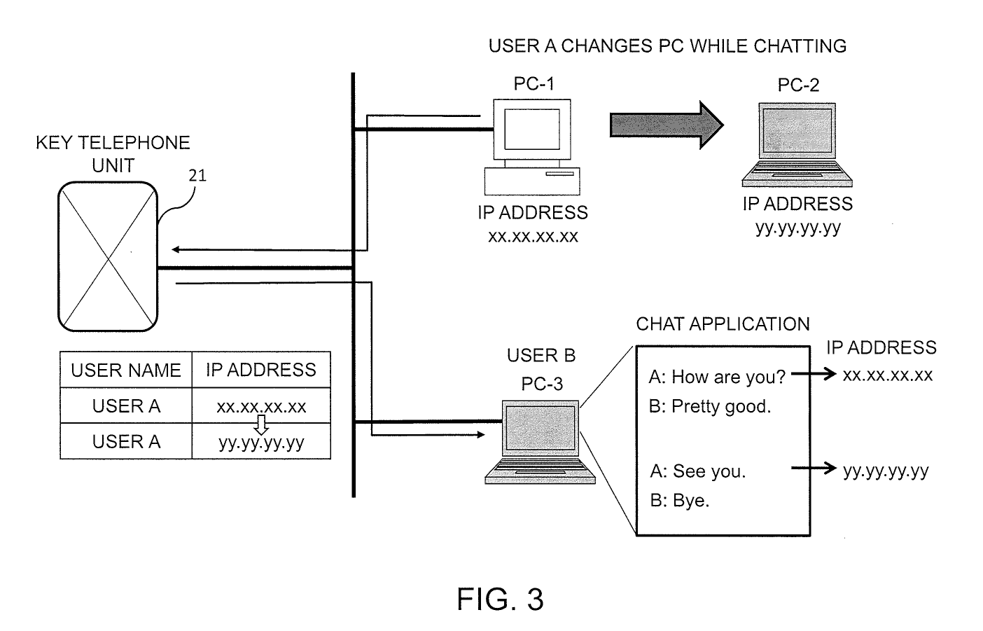

FIG. 3 shows a chat system according to a second exemplary embodiment of the present invention. In this embodiment, the user terminal A changes from a client PC-1 with an IP address of xx.xx.xx.xx to a client PC-2 with an IP address of yy.yy.yy.yy while the user terminal A is chatting with a client PC-3 of the user terminal B. In this case, the IP address of the user terminal A is transmitted from the client PC-2 to the key telephone unit 21, which rewrites the IP address at an entry in the table where the name of the user terminal is A into yy.yy.yy.yy. Then the key telephone unit 21 includes the IP address of the client PC-2, i.e., yy.yy.yy.yy, in the presence information and transmits the presence information to the client PC-3 of the user terminal B. Thus, when the presence information of the user terminal A changes, the change of the IP address is transmitted to the user terminal B. The user terminal chat program provided on the client PC-3 changes the addressee to the client PC-2 with the IP address of yy.yy.yy.yy and continues chatting.

In this manner, even if at least one of the user terminals A and B changes its device during chatting (for example, from a desktop PC to a laptop PC), the changed IP address is transmitted to the key telephone unit 21. In accordance with the buddy table, the key telephone unit 21 distributes a new IP address to other terminals. As a result, the chatting can be continued.

In the above embodiment, when the chat application is started, the key telephone unit 21 obtains an IP address of a user terminal and distributes it as presence information to registrants in the buddy list table. However, with another configuration of the present invention, when the chat application is started, the user terminal chat program may inquire of the key telephone unit 21 an IP address of a chat addressee to obtain the IP address.

As described above, the presence server included in the key telephone unit 21 includes the received IP address on presence information and provides the presence information to the user terminal(s) listed on the buddy list table. The user terminal can refer to the obtained presence information and use the obtained IP address to establish peer-to-peer chat communication without use of a chat server. In any case, according to the present invention, exemplary advantage is that chat communication can be achieved without any chat server.

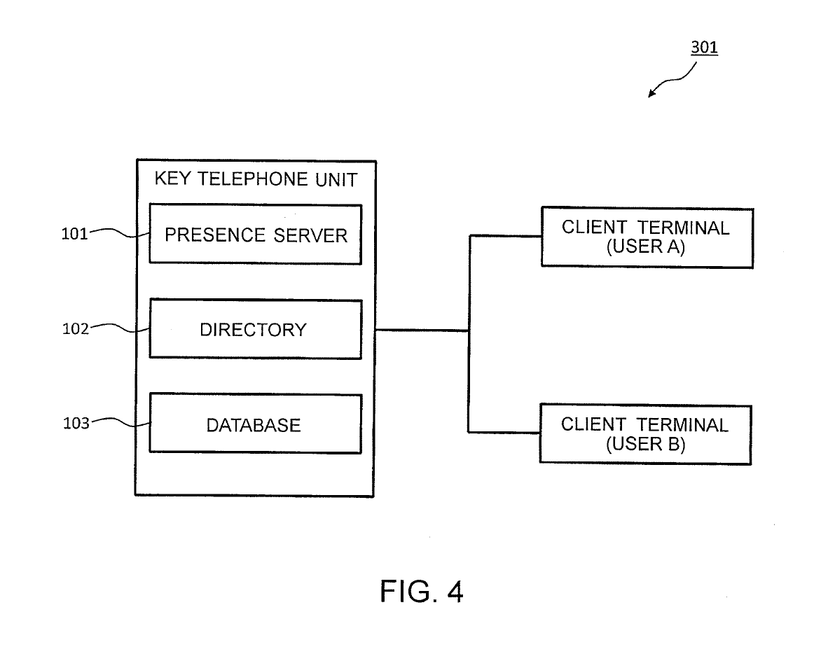

FIG. 4 is a block diagram showing a chat system shown in FIG. 2. As shown in FIG. 4, the key telephone unit 21 includes a presence server 101, a directory 102, and a database 103. The key telephone unit 21 is connected to a client terminal of the user terminal A and a client terminal of the user terminal B.

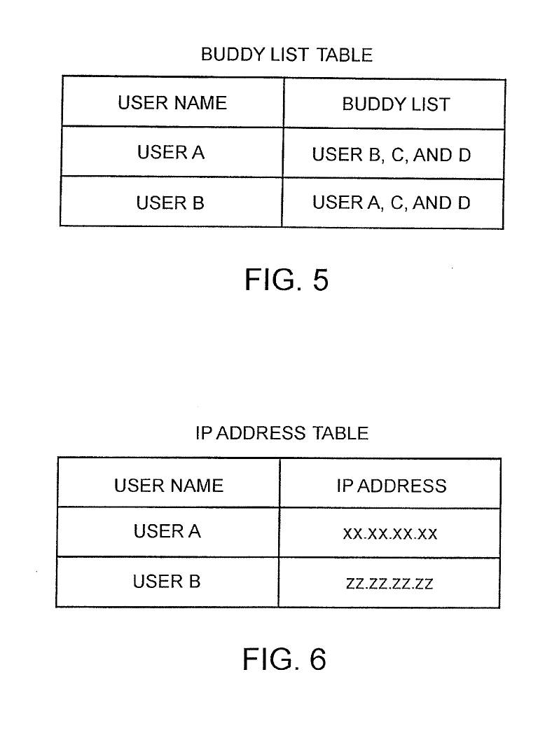

The database 103 of the key telephone unit 21 stores therein a buddy list table as shown in FIG. 5. For example, when the presence server 101 receives an IP address from the user terminal B, it accesses to a buddy list corresponding to the user terminal B. Subsequently, the presence server 101 selects the registered user terminal (e.g., the user terminal B) to include the received IP address in corresponding presence information, and transmits the presence information to an addressee(s), i.e., the user terminals A, C and D.

Each of the addressees, e.g., the user terminal A, stores the IP address of the user terminal B. Thus, the user terminal A can chat with the user terminal B.

FIG. 6 shows an IP address table stored in each of terminals (i.e., clients PC-1, PC-2, PC-3, and the like). This example shows an IP address table of the user terminal A. As shown in FIG. 6, the IP address table of each of the user terminals includes IP addresses of any clients that have had communication with that user terminal (e.g., the user terminal B) as well as its own IP address.

Specifically, a user terminal chat program of a user terminal has an IP address table including a list of registered user terminals and IP addresses of them. The user terminal chat program also has a function of transmitting an IP address of a user terminal selected from the list of the registered user terminals (as an addressee of chat data) as well as its own IP address. Thus, there can be provided a chat system that can achieve peer-to-peer chat communication between user terminals.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. For example, the aforementioned key telephone unit may be any device that can eliminate the need for a chat server. Therefore, the key telephone unit may include an IP telephone device.

What is claimed is:

1. A chat system comprising:
a key telephone unit; and
a plurality of user terminals connected to the key telephone unit,
wherein, when the key telephone unit receives an IP address of any one of the user terminals, it refers to a list in a list table corresponding to the IP address and transmits the IP address to an addressee in the list, thereby achieving chat communication between the user terminal and the addressee which is another one of the user terminals,
peer-to-peer chat communication is established between the user terminals according to the IP address of the user terminal and an IP address of the addressee, and
the IP addresses of the user terminal and the addressee are included and transmitted in presence information.

2. The chat system as recited in claim 1, wherein the chat system configured to continue the chat communication by switching a user terminal being used into another user terminal during the peer-to-peer chat communication.

3. The chat system as recited in claim 1, wherein, the chat system configured to notify change of the IP addresses when the presence information is changed.

4. The chat system as recited in claim 1, wherein the key telephone unit comprises a presence server operable to transmit the presence information including the IP address.

5. The chat system as recited in claim 1, wherein each of the user terminals comprises an IP address table which operable to store at least one of IP addresses of the user terminals.

6. The chat system as recited in claim 1, wherein each of the user terminals comprises an IP address table which operable to include lists of registered user terminals and IP addresses corresponding to the registered user terminals, and
each of the user terminals operable to transmit one of the IP addresses corresponding to selected one of the registered user terminals in addition to its own IP address.

7. The chat system as recited in claim 1, wherein each of the user terminals configured to receive presence information including an IP address of another one of the user terminals and configured to read out an IP address from chat data transmitted by another one of the user terminals in chat communication.
